(19) United States
(12) Patent Application Publication
(10) Pub. No.: US 2026/0335905 A1
(43) Pub. Date: Oct. 29, 2026

(54) Device for Separating Secondary Materials from a Base Liquid and Associated Systems and Methods

(71) Applicant: Battelle Energy Alliance, LLC, Idaho Falls, ID (US)

(72) Inventors: Steven D. HERRMANN, Idaho Falls, ID (US); Guy L. FREDRICKSON, Idaho Falls, ID (US); Tae-Sic YOO, Idaho Falls, ID (US)

(21) Appl. No.: 19/237,362

(22) Filed: Jun. 13, 2025

Related U.S. Application Data
(60) Provisional application No. 63/659,773, filed on Jun. 13, 2024.
(60) Provisional application No. 63/707,483, filed on Oct. 15, 2024.

(51) Int. Cl. B03C 5/02

(52) U.S. Cl. CPC B03C 5/02

(57) ABSTRACT

A device for separating secondary materials from a base liquid includes a base including a central aperture defined by an inward protrusion. The device further includes a collection region defined over the base between the inward protrusion and an outer wall. The device also includes a carrier metal disposed in the collection region, the carrier metal formulated to capture the secondary materials in the base liquid. The device further includes an upper wall including one or more apertures defined through the upper wall, wherein the apertures are positioned radially outward of the central passage. An associated system and method are also disclosed.

### CROSS-REFERENCE TO RELATED APPLICATIONS

This application claims the benefit under 35 U.S.C. § 119(e) of U.S. Provisional Patent Application Ser. No. 63/659,773, filed Jun. 13, 2024, and of U.S. Provisional Patent Application Ser. No. 63/707,483, filed Oct. 15, 2024, the disclosure of each of which is hereby incorporated herein in its entirety by this reference.

### STATEMENT REGARDING FEDERALLY SPONSORED RESEARCH OR DEVELOPMENT

This invention was made with government support under Contract Number DE-AC07-05-ID14517 awarded by the United States Department of Energy. The government has certain rights in the invention.

### TECHNICAL FIELD

Devices for separating secondary materials from base liquids are disclosed. More specifically, material separators and associated systems and methods are disclosed.

### BACKGROUND

Liquid systems are used in many situations. For example, liquid systems may be used to transfer heat from a system that generates heat to a system that is configured to absorb or dissipate heat. In other examples, liquid may be used to generate power such as through movement of the liquid, through expansion of the liquid (e.g., through a phase change), or through chemical or nuclear reactions in the liquid. In some cases, reactive liquid systems may be used to produce desirable by-products through reactions in the liquid system that may be separated and extracted for use in other processes, such as medical procedures. Liquid systems may also be used to transfer materials suspended or dissolved in the liquid, such as through deposition processes.

In liquid systems, the presence of impurities may create inefficiencies in the system. For example, the accumulation of impurities in these systems can have deleterious effects on their operations, such as fouling of system components or parasitic reactions that lower system efficiencies.

### SUMMARY

Embodiments of the disclosure include a device for separating secondary materials from a base liquid. The device includes a base including a central aperture defined by an inward protrusion. A collection region is defined over the base between the inward protrusion and an outer wall of the base. A carrier metal is disposed in the collection region, and the carrier metal is formulated to capture the secondary materials in the base liquid. The device further includes an upper wall including one or more apertures defined through the upper wall, wherein the one or more apertures are positioned radially outward of the central aperture.

Other embodiments of the disclosure include a system including a first electrode disposed in a fluid reservoir configured to contain a fluid comprising a base fluid and secondary materials. A second electrode is disposed in the fluid reservoir, and the second electrode is configured to exhibit an opposite polar charge from the first electrode. The system further includes a separator. The separator includes a central shaft coupled to the second electrode. The separator also includes a base with a central passage defined by an inward protrusion. A collection region is defined over the base between the inward protrusion and an outer wall. The system further includes an upper wall including one or more apertures defined through the upper wall, wherein the one or more apertures are positioned radially outward of the central passage.

Another embodiment of the disclosure includes a method of separating secondary materials from a fluid. The method includes rotating a separator in a fluid reservoir containing a fluid including a base fluid and secondary materials. The separator includes a central aperture extending through a base of the separator and one or more apertures in an upper wall of the separator. The method further includes inducing fluid flow through the separator from the central aperture to the one or more apertures in the upper wall of the separator. Secondary materials are collected in a collection region defined over the base of the separator between the central aperture and a radially outer wall of the separator.

### BRIEF DESCRIPTION OF THE DRAWINGS

While the specification concludes with claims particularly pointing out and distinctly claiming embodiments of the disclosure, the advantages of embodiments of the disclosure may be more readily ascertained from the following description of embodiments of the disclosure when read in conjunction with the accompanying drawings in which:

FIG. 1 illustrates a schematic view of a liquid system in accordance with embodiments of the disclosure;

FIGS. 2A and 2B illustrate perspective views of a separator in accordance with embodiments of the disclosure;

FIG. 3 illustrates a cross-sectional view of the separator of FIGS. 2A and 2B;

FIG. 4 illustrates a bottom view of the separator of FIGS. 2A and 2B with the base removed in accordance with embodiments of the disclosure;

FIG. 5 illustrates a cross-sectional view of the bottom portion of the separator of FIGS. 2A and 2B with the base removed in accordance with embodiments of the disclosure;

FIG. 6A illustrates a side view of the base of the separator of FIGS. 2A and 2B in accordance with embodiments of the disclosure;

FIG. 6B illustrates a cross-sectional view of the base of the separator of FIGS. 2A and 2B;

FIGS. 7, 8, and 9 illustrate flow charts representative of methods of separating secondary materials from a base liquid in accordance with embodiments of the disclosure;

FIG. 10 illustrates a cross-sectional view of the bottom portion of the separator of FIGS. 2A and 2B with the base removed in accordance with embodiments of the disclosure;

FIG. 11 illustrates a side view of the base of the separator of FIGS. 2A and 2B in accordance with embodiments of the disclosure;

FIG. 12 illustrates a reactor in accordance with embodiments of the disclosure; and

FIG. 13 illustrates a reactor in accordance with embodiments of the disclosure.

### DETAILED DESCRIPTION

The following description provides specific details, such as material compositions, shapes, and sizes, in order to provide a thorough description of embodiments of the disclosure. However, a person of ordinary skill in the art would understand that the embodiments of the disclosure may be practiced without employing these specific details. Indeed, the embodiments of the disclosure may be practiced in conjunction with conventional techniques employed in the industry.

Drawings presented herein are for illustrative purposes only and are not meant to be actual views of any particular material, component, structure, device, or system. Variations from the shapes depicted in the drawings as a result, for example, of manufacturing techniques and/or tolerances, are to be expected. Thus, embodiments described herein are not to be construed as being limited to the particular shapes or regions as illustrated, but include deviations in shapes that result, for example, from manufacturing. For example, a region illustrated or described as box-shaped may have rough and/or nonlinear features, and a region illustrated or described as round may include some rough and/or linear features. Moreover, sharp angles that are illustrated may be rounded, and vice versa. Thus, the regions illustrated in the figures are schematic in nature, and their shapes are not intended to illustrate the precise shape of a region and do not limit the scope of the present claims. The drawings are not necessarily to scale. Additionally, elements common between figures may retain the same numerical designation.

As used herein, the terms “configured” and “configuration” refers to a size, a shape, a material composition, a material distribution, orientation, and arrangement of at least one feature (e.g., one or more of at least one structure, at least one material, at least one region, at least one device) facilitating use of the at least one feature in a pre-determined way.

As used herein, the term “substantially” in reference to a given parameter means and includes to a degree that one skilled in the art would understand that the given parameter, property, or condition is met with a small degree of variance, such as within acceptable manufacturing tolerances. By way of example, depending on the particular parameter, property, or condition that is substantially met, the parameter, property, or condition may be at least 90.0 percent met, at least 95.0 percent met, at least 99.0 percent met, at least 99.9 percent met, or even 100.0 percent met.

As used herein, “about” in reference to a numerical value for a particular parameter is inclusive of the numerical value and a degree of variance from the numerical value that one of ordinary skill in the art would understand is within acceptable tolerances for the particular parameter. For example, “about” in reference to a numerical value may include additional numerical values within a range of from 90.0 percent to 110.0 percent of the numerical value, such as within a range of from 95.0 percent to 105.0 percent of the numerical value, within a range of from 97.5 percent to 102.5 percent of the numerical value, within a range of from 99.0 percent to 101.0 percent of the numerical value, within a range of from 99.5 percent to 100.5 percent of the numerical value, or within a range of from 99.9 percent to 100.1 percent of the numerical value.

As used herein, relational terms, such as “below,” “lower,” “bottom,” “upper,” “above,” “top,” and the like, may be used for ease of description to describe one element's or feature's relationship to another element(s) or feature(s) as illustrated in the drawings. Unless otherwise specified, the spatially relative terms are intended to encompass different orientations of the materials in addition to the orientation depicted in the figures. For example, if materials in the figures are inverted, elements described as “below” or “under” or “on bottom of” other elements or features would then be oriented “above” or “on top of” the other elements or features. Thus, the term “below” can encompass both an orientation of above and below, depending on the context in which the term is used, which will be evident to one of ordinary skill in the art. The materials may be otherwise oriented (e.g., rotated 90 degrees, inverted, flipped) and the spatially relative descriptors used herein interpreted accordingly.

As used herein, the singular forms “a,” “an,” and “the” are intended to include the plural forms as well, unless the context clearly indicates otherwise.

As used herein, the term “and/or” means and includes any and all combinations of one or more of the associated listed items.

As used herein, the terms “vertical,” “longitudinal,” “horizontal,” and “lateral” are in reference to a major plane of a structure and are not necessarily defined by earth's gravitational field. A “horizontal” or “lateral” direction is a direction that is substantially parallel to the major plane of the structure, while a “vertical” or “longitudinal” direction is a direction that is substantially perpendicular to the major plane of the structure. The major plane of the structure is defined by a surface of the structure having a relatively large area compared to other surfaces of the structure.

In many liquid systems, the presence of secondary materials, such as impurities, in the fluid may create inefficiencies in the system, such as by reducing reactivity in reactive systems, restricting flow along flow paths, and or causing damage to moving parts in the system. For example, in reactive systems, such as molten salt systems, byproducts may be created through corrosion, reactions, or fission. The corrosion byproducts, reaction byproducts, or fission byproducts may include insoluble solid particles or soluble materials that reduce reactivity of the surrounding base materials or react with other materials in the fluid to introduce inefficiencies. Accumulation of these byproducts in these systems can have deleterious effects on their operations, such as fouling of system components or parasitic reactions that lower system efficiencies. For example, nuclear and chemical reactions in molten salts, such as lithium chloride (LiCl), sodium chloride (NaCl), potassium chloride (KCl), may result in undesirable fission and corrosion products. In other examples, the reactions may result in desirable materials, such as fission product molybdenum-99 (Mo-99), that may be separated and extracted for use in other processes, such as medical procedures. The secondary material may be separated from the base material based on a density difference, an electrochemical potential difference, or a thermodynamic stability difference between the base material and the secondary material. The secondary material may be removed using centripetal force or electromotive force in combination with centripetal force. Heavier materials may separate from the base material and be recovered.

Separating the secondary materials from the liquid may be beneficial, such as to improve efficiencies within the system or to remove desirable secondary materials from the system. Many systems have reservoirs (e.g., tanks, containers, containment areas, cores, cells, etc.) where the fluids are stored. In some embodiments, such as reactive systems, the reactions may take place in the reservoir. The reservoirs may be an area where fluid flow slows and any solids suspended in the fluid are more likely to collect. A device configured to separate secondary materials may be disposed in the reservoir and used to collect the secondary materials, which may then be removed from the system.

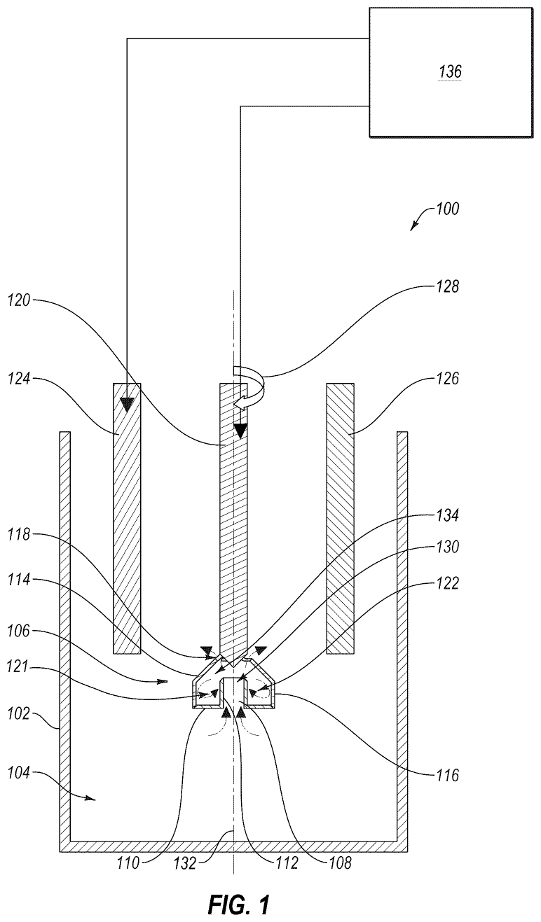

FIG. 1 illustrates a system 100 including a reservoir 102 containing a liquid 104. The system 100 includes a separator 106 disposed in the liquid 104 within the reservoir 102. The separator 106 is configured to induce flow in the reservoir 102. The induced flow may cause any solid or insoluble particles in the liquid 104 to be suspended in the liquid 104 instead of the solid particles settling in a bottom portion of the reservoir 102.

The separator 106 may be coupled to a central shaft 120. The central shaft 120 is configured to rotate the separator 106 as indicated by arrow 128. The separator 106 may include geometric features that are configured to induce the liquid 104 to flow through the separator 106 when the separator 106 rotates in the liquid 104. In the embodiment illustrated in FIG. 1, the separator 106 includes a central aperture 108 defined in a base 110 of the separator 106. The central aperture 108 is further defined by an inward protrusion 112 extending from the base 110 to an interior region 130 of the separator 106. The base 110 may extend radially outward to an outer wall 116, which may extend up to an upper wall 114. The upper wall 114 includes one or more apertures 118 defined through the upper wall 114. As the separator 106 rotates, the one or more apertures 118 in the upper wall 114 may induce fluid flow out of the interior region 130 of the separator 106. The fluid flow out of the separator 106 creates a vacuum that induces fluid flow into the interior region 130 of the separator 106 through the central aperture 108 in the base 110 of the separator 106.

As illustrated, the central aperture 108 is axially aligned with the central shaft 120 along an axis 132 of the separator 106. The central aperture 108 may have a major cross-sectional dimension (e.g., diameter, width, apothem) that is less than or equal to a major cross-sectional dimension of the central shaft 120, such that the central aperture 108 does not extend radially from the axis 132 a greater distance than the central shaft 120 (e.g., such that the central aperture 108 has a cross-sectional shape that lies within a cross-sectional footprint of the central shaft 120 along the axis 132).

As illustrated, the one or more apertures 118 defined in the upper wall 114 of the separator 106 are positioned in a region radially outward of the central aperture 108 and the central shaft 120. A radial distance from the axis 132 to the apertures 118 is greater than the major cross-sectional dimension of the central aperture 108 and the central shaft 120.

The upper wall 114 may extend a distance above a top of the inward protrusion 112, such that a gap 134 is defined between the upper portion of the inward protrusion 112 and the upper wall 114. The gap 134 may facilitate fluid flow through the interior region 130 of the separator 106. The fluid flow in the interior region 130 of the separator 106 may facilitate the separation of secondary materials within the separator 106. In some embodiments, as illustrated in FIG. 1, the upper wall 114 extends from the outer wall 116 to the central shaft 120 at an angle in a range from about 0° to about 90°, such as an angle in the range from about 10° to about 80°, or an angle in the range from about 30° to about 60° relative to the axis 132. In the embodiment illustrated in FIG. 1, the outer wall 116 extends a greater distance from the base 110 than the inward protrusion 112. In other embodiments, the outer wall 116 and the inward protrusion 112 may extend a distance from the base 110 that is substantially the same. In other embodiments, the outer wall 116 extends a distance from the base 110 that is less than the distance from the base 110 that the inward protrusion 112 extends.

The design of the separator 106, such as the arrangement of the one or more apertures 118 and the central aperture 108 and/or the shape and/or size of the inward protrusion 112, base 110, outer walls 116, and upper walls 114 of the separator 106 may induce vortices 121 in the interior region 130 of the separator 106. The vortices 121 may cause the fluid to flow into a collection region 122 defined over the base 110 between the inward protrusion 112 and the outer wall 116. Solids suspended in the fluid may have a higher molecular density than the surrounding fluid (e.g., the base material of the fluid). The increased density may cause the solids to settle or concentrate in the collection region 122 and remain in the collection region 122 while the fluid flows out of the interior region 130 of the separator 106 through the one or more apertures 118. The vortices 121 may also facilitate separating secondary materials from the fluid where the secondary materials have a higher molecular density even when the secondary materials are dissolved in the fluid. By way of example only, neodymium chloride may accumulate in a base salt of lithium and potassium chloride. Neodymium chloride has a standard density of about 4.13 g/cc while that of the base salt is ~2 g/cc. The neodymium chloride may be separated from the base salt and concentrated within the collection region 122 using the separator 106 according to embodiments of the disclosure.

In some embodiments, a gas sparge may be disposed in the liquid 104. For example, a reactive gas sparge may feed a reactive gas into the liquid beneath the separator 106. The reactive gas fed in by the reactive gas sparge may convert soluble species in the liquid to insoluble species. For example, soluble neodymium (III) chloride in a base fluid may react with an oxygen-bearing sparge gas to produce insoluble neodymium oxides and oxychlorides. The resulting insoluble species may then be concentrated in the collection region 122 of the separator.

In some embodiments, the system 100 also includes an electrode 124 disposed in the liquid 104. The central shaft 120 may also be configured as an electrode having (e.g., exhibiting) a polar charge that is opposite the polar charge of the electrode 124. For example, the electrode 124 may be configured as an anode and the central shaft 120 may be configured as a cathode, such that the entire separator 106 forms a cathode. In other embodiments, the electrode 124 may be configured as a cathode and the central shaft 120 may be configured as an anode. The polar charges of the electrode 124 and the central shaft 120 may cause secondary materials having different electrical energies (e.g., electrical potentials) or polarities to move differently within the interior region 130 of the separator 106. For example, secondary materials having lower decomposition potentials than the molecules of the liquid 104 may be attracted by the cathode, such that if the central shaft 120 is the cathode, the secondary materials may be attracted to the surfaces of the central shaft 120 and the separator 106. When the secondary materials are attracted to the surfaces of the central shaft 120 and the separator 106, the secondary materials may flow into the interior region 130 of the separator 106 and concentrate within the collection region 122. The polar charges of the electrode 124 and the central shaft 120 may be provided by a power source and/or a system controller 136 applying a voltage or potential between the electrode 124 and the central shaft 120. The electrode 124 may function as a working electrode and the central shaft may function as a counter electrode. As discussed above, the electrode 124 may be configured as an anode or a cathode, and the central shaft 120 may be configured as the other of the anode and the cathode.

The voltage applied between the working electrode and the counter electrode (e.g., the electrode 124 and the central shaft 120) may approach the decomposition potential or voltage of a secondary material that is less thermodynamically stable than the base liquid 104. For example, the voltage applied may be about 100 mV less than the decomposition potential of a secondary material that is less thermodynamically stable than the base liquid 104. The voltage operating between the anode and cathode in the liquid 104 may result in the formation of precipitates of the secondary materials, which may then be separated out by the separator 106. In other words, the voltage may be selected to form the precipitates without depositing the secondary materials. By way of example only, neodymium (III) chloride may accumulate in a base salt of lithium and potassium chloride. The neodymium (III) chloride has a standard decomposition potential at 500 °C of about 2.94 V while the base salt has a standard decomposition potential at 500 °C of about 3.57 V. After applying a voltage between the anode and the cathode, neodymium (II) chloride may form and be separated from the base salt and concentrated within the collection region 122 using the separator 106 according to embodiments of the disclosure.

The separator 106 may be formed from a conductive material configured to withstand temperatures in the associated system 100. For example, the separator 106 may be formed from materials such as copper, aluminum, 316 stainless steel, nickel based alloys (e.g., inconel), molybdenum based alloys (e.g., titanium-zirconium-molybdenum (TZM)), etc. Higher temperature applications, such as molten salt applications, may utilize a separator 106 formed from a material having a higher melting point, such as 316 stainless steel, nickel based alloys, or molybdenum based alloys. In lower temperature applications, less expensive materials having lower melting points may be used.

In some embodiments, the system 100 may include a sensor 126 disposed in the liquid 104. The sensor 126 may be configured to detect and/or monitor characteristics of the liquid 104, such as temperature, composition, conductivity, reference electrode for relative electric potentials or voltages on the separator 106 and the electrode 124, etc. The sensor 126 may be configured to detect and/or monitor the presence and/or concentration of specific secondary materials in the liquid 104. In some embodiments, a system controller 136 may be configured to control the separator 106 based on input from the sensor 126. For example, the controller may change a rotational speed of the separator 106 based on input from the sensor 126. In another example, the controller may change a voltage between the electrode 124 and the separator 106 based on input from the sensor 126. In another example, the controller may turn the separator 106 on and off (e.g., rotation and/or voltage) based on input from the sensor 126.

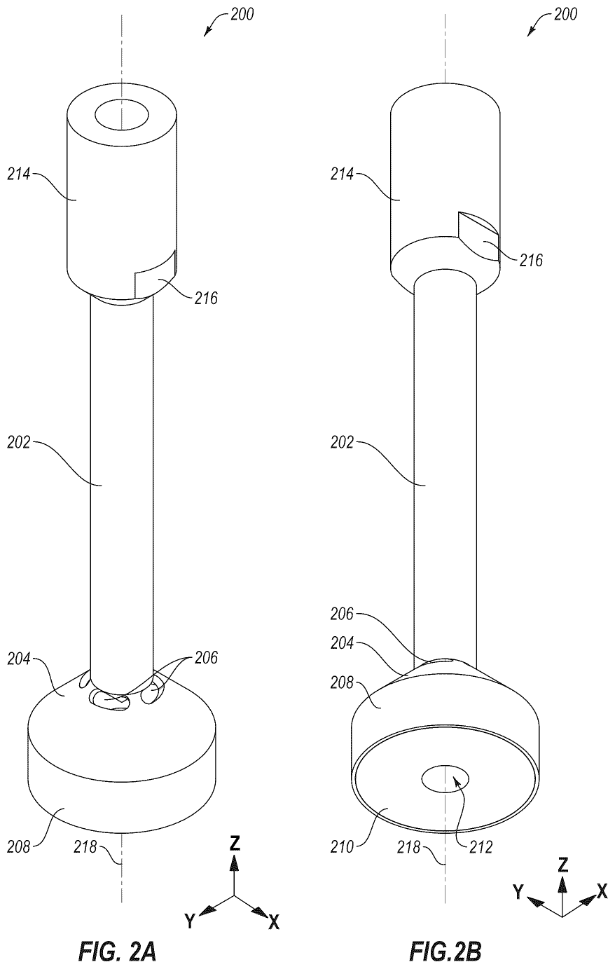

FIGS. 2A and 2B illustrate perspective views of an embodiment of a separator 200, such as separator 106 (FIG. 1). The separator 200 may include a central shaft 202 configured to suspend the separator 200 in a liquid and configured to receive a rotating input to the separator 200. For example, the central shaft 202 may be configured to be coupled to a rotating input, such as an electric motor or gear box. In the embodiment illustrated in FIGS. 2A and 2B, the central shaft 202 includes a collar 214. The collar 214 may be configured to couple the central shaft 202 to a rotating input. As illustrated in FIG. 2B, the collar 214 includes interface structures 216, such as flat interface structures, set-screws, locking pins, etc., that are configured to rotationally secure the collar 214 to the rotational input.

The separator 200 also includes a base 210, an outer wall 208, and an upper wall 204 defining an outer shape of a bottom portion of the separator 200 that is configured to be disposed in the liquid. The base 210 includes a central aperture 212 (e.g., central fluid passage or central passage) and the upper wall 204 includes multiple apertures 206 defined circumferentially about the upper wall 204. In the embodiment illustrated in FIGS. 2A and 2B, the apertures 206 are oval shaped (e.g., stadium shaped) having semicircular ends joined by substantially straight sides. In other embodiments, the apertures 206 may have other shapes, such as circular shapes, triangular shapes, rectangular shapes, etc. In some embodiments, the apertures 206 may have irregular shapes (e.g., asymmetrical shapes).

In the embodiment illustrated in FIGS. 2A and 2B, the apertures 206 are substantially evenly spaced (e.g., have substantially equal angular spacing) about an axis 218 of the separator 200. The apertures 206 are positioned radially outward of the central shaft 202 in the upper wall 204 of the bottom portion of the separator 200. In the embodiment illustrated in FIGS. 2A and 2B, each element of the separator 200 has a substantially circular cross section. The central aperture 212 has a diameter less than or equal to a diameter of the central shaft 202, such that the apertures 206 in the upper wall 204 are also positioned radially outward of the central aperture 212.

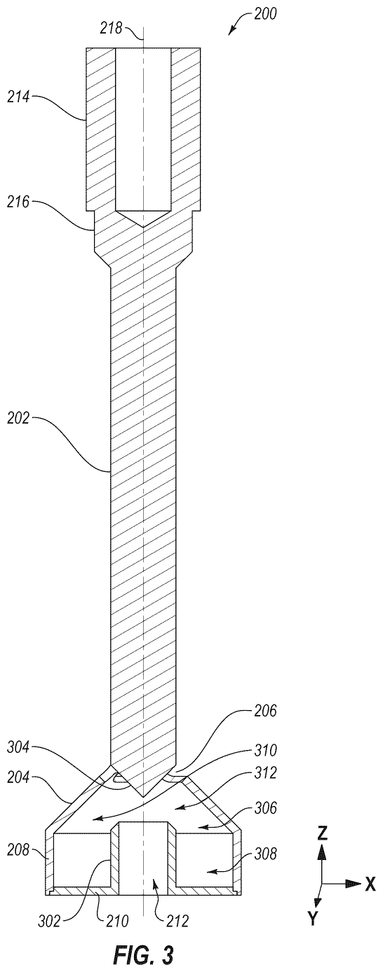

FIG. 3 illustrates a cross-sectional view of the separator 200. The base 210 of the separator 200 includes an inward protrusion 302 that at least partially defines the central aperture 212. The inward protrusion 302 extends from the base 210 in a direction along the Z-axis into an interior region 306 of the separator 200. The inward protrusion 302 and the outer wall 208 define a collection region 308 in the interior region 306. The collection region 308 may be the region of the interior region 306 above the base 210 between the inward protrusion 302 and the outer wall 208.

A flow diverter 304 is positioned over the central aperture 212. The flow diverter 304 may be substantially conically shaped to divert fluid entering through the central aperture 212 toward the upper wall 204 or the outer wall 208. The flow diverter 304 may be configured to induce vortices into the fluid flow, such that the fluid may be diverted into the collection region 308 of the interior region 306. As discussed above, materials, such as secondary materials or solid particles, having a higher density than the base fluid may concentrate in the collection region 308 as the fluid flows through the interior region 306. In some cases, the separator 200 may be polarized through an applied voltage to further attract secondary materials or solid particles with different thermodynamic stability properties than the base materials of the fluid.

In the embodiment illustrated in FIG. 3, the inward protrusion 302 and the outer wall 208 have substantially a same vertical height in a direction along the Z-axis, such that the inward protrusion 302 and the outer wall 208 extend substantially the same distance in the Z-direction from the base 210. The upper wall 204 may extend from the outer wall 208 to the central shaft 202 at an angle 310 relative to the Z-axis. The angle 310 may be in a range from about 0° to about 90°, such as from about 10° to about 80°, or from about 30° to about 60°. The dimensions and arrangement of the inward protrusion 302, the outer wall 208, and the upper wall 204 may be such that a gap 312 is defined between the top of the inward protrusion 302 and the upper wall 204 to facilitate the formation of the vortices in the interior region 306 of the separator 200.

As discussed above, the separator 200 includes multiple apertures 206 extending through the upper wall 204. In the embodiment illustrated in FIG. 3, the apertures 206 extend through the upper wall 204 in an area adjacent to the central shaft 202, such as where the upper wall 204 meets the central shaft 202. The apertures 206 are radially outward of the central aperture 212. The flow diverter 304 may be configured to direct flow toward the apertures 206.

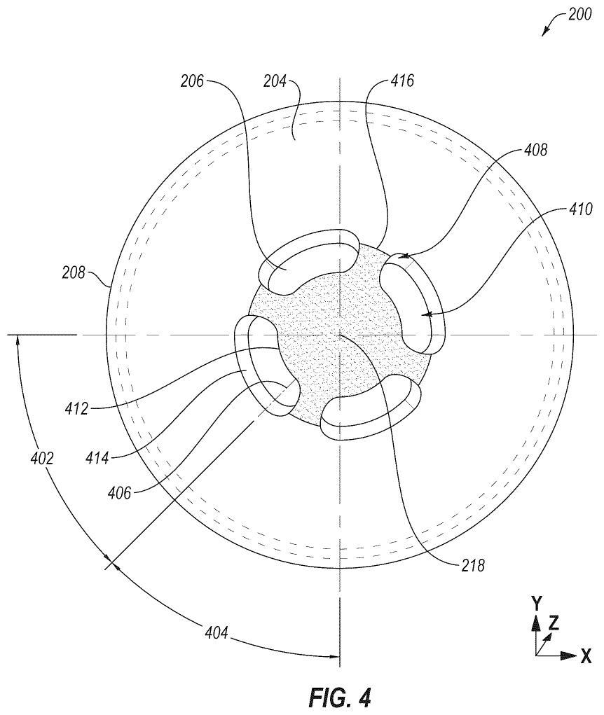

FIG. 4 illustrates a view of the separator 200 upward from the bottom region with the base 210 removed to illustrate the features of the interior region 306 of the separator 200. The apertures 206 are angularly spaced about the axis 218 of the separator 200. In the embodiment illustrated in FIG. 4, the separator 200 includes four apertures 206. In some embodiments, the separator 200 may include more than four apertures 206, such as five apertures 206, six apertures, ten apertures, etc. In other embodiments, the separator 200 may include fewer than four apertures 206, such as three apertures 206, two apertures 206, or even one aperture 206.

The apertures 206 may have different shapes, such as circular shapes, oval shapes, rectangular shapes, triangular shapes, etc. In the embodiment illustrated in FIG. 4, the apertures 206 have oval shapes (e.g., stadium shapes) having semicircular portions 408 on each end and a constant width portion 410 extending between the semicircular portions 408. The point where the semicircular portion 408 meets the constant width portion 410 defines a diameter segment 406, which also defines a width of the constant width portion 410. The constant width portion 410 follows a circular path about the axis 218, such that an inner surface 412 defining the constant width portion 410 of the aperture 206 has substantially a same radial distance from the axis 218 at each point along the constant width portion 410 of the aperture 206, and an outer surface 414 defining the constant width portion 410 of the aperture 206 has substantially a same radial distance from the axis 218 at each point along the constant width portion 410 of the aperture 206. A length of the constant width portion 410 of each of the apertures 206 is defined by an aperture span angle 402, which defines the angular displacement between the diameter segments 406 at each end of a single aperture 206 of the apertures 206.

The apertures 206 may be separated by a separator 416 between the semicircular portions 408 of adjacent apertures 206. The separator 416 may be sufficiently thick to induce flow in the fluid when the separator 200 rotates. The thickness of the separator 416 may be defined by an aperture separation angle 404 (e.g., an angular spacing between the diameter segment 406 of the adjacent semicircular portions 408) and a radius of the adjacent semicircular portions 408.

In embodiments having equally spaced apertures 206, the aperture span angle 402 and the aperture separation angle 404 may combine to define equal angles about the axis 218. For example, the aperture span angle 402 and the aperture separation angle 404 may satisfy the following equation:

$$A + B = \frac{360}{C}$$

where A=aperture span angle 402, B=aperture separation angle 404, and C=the number of apertures 206. For example, in embodiments having four equally spaced apertures 206, the aperture span angle 402 and the aperture separation angle 404 add up to 90° (e.g., the aperture span angle 402 and the aperture separation angle 404 are complementary angles) because 360° divided by 4 is 90°. In some embodiments, the aperture span angle 402 and the aperture separation angle 404 are substantially the same. For example, in the embodiment illustrated in FIG. 4, if the aperture span angle 402 and the aperture separation angle 404 are each 45° the aperture span angle 402 and the aperture separation angle 404 will each be substantially the same while facilitating four apertures 206 equally spaced about the axis 218.

In the embodiment illustrated in FIG. 4, the apertures 206 extend through the upper wall 204 at an angle substantially normal to (e.g., perpendicular to) the upper wall 204. In some embodiments, the apertures 206 extend through the upper wall 204 at an acute angle (e.g., an angle between about 0 degrees and about 90 degrees) relative to a direction of rotation, such that the apertures 206 are configured to operate in a similar manner to a pitched blade impeller when the separator 200 rotates.

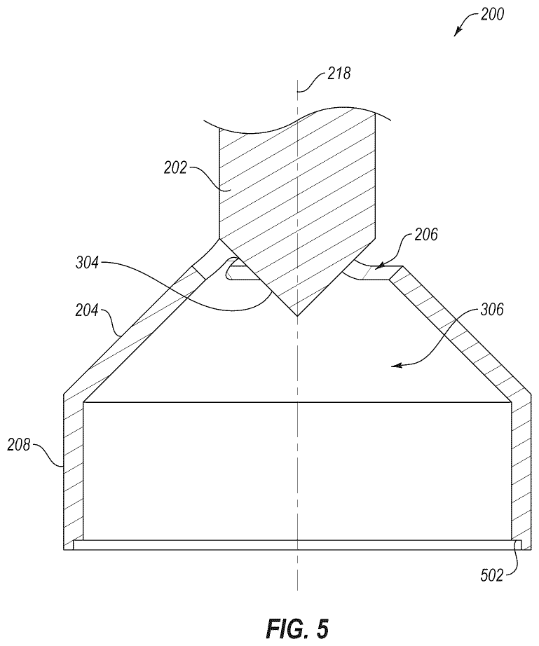

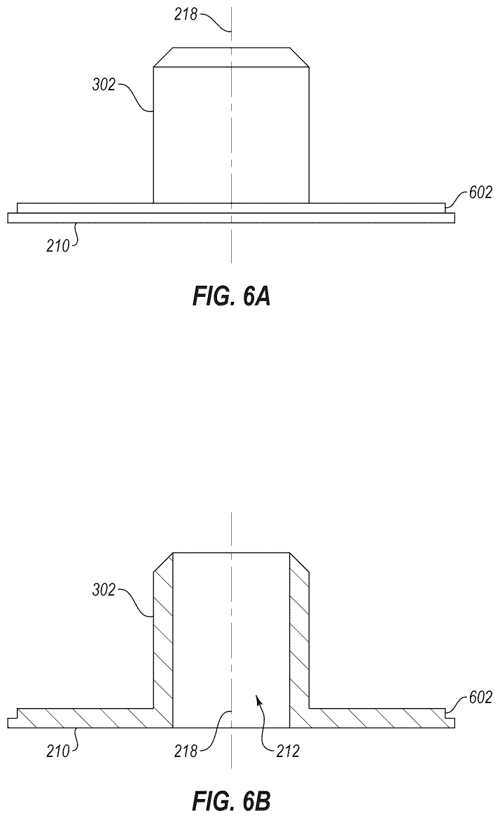

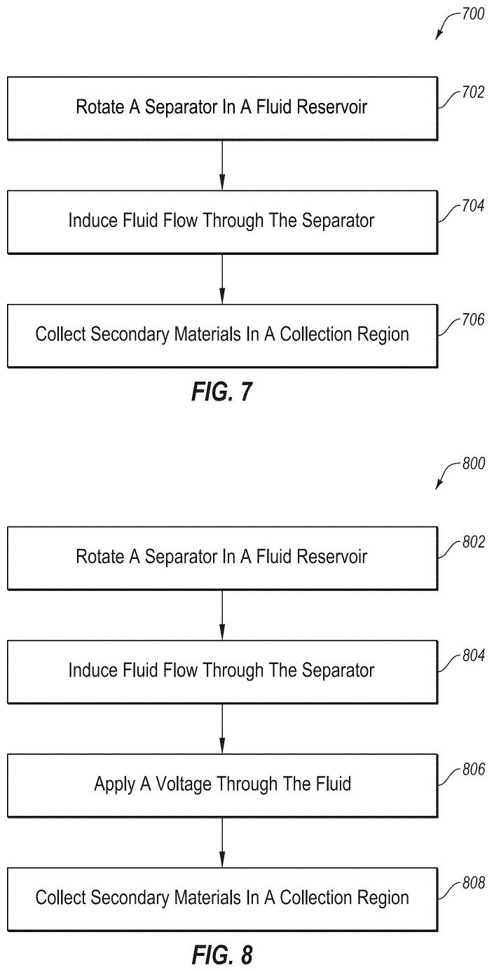

In FIGS. 5-6B, an embodiment of the separator 200 with a removable base 210 is illustrated. Configuring the separator 200 with a removable base 210 may facilitate removing separated secondary materials from the separator 200. FIG. 5 illustrates a cross-sectional view of the bottom portion of the separator 200 with the base 210 removed. FIGS. 6A and 6B illustrate different views of the removed base 210.

The interior region 306 of the separator 200 defined by the outer wall 208 and the upper wall 204 may be substantially free of other protrusions or features with the base 210 removed. In some embodiments, the upper wall 204 and/or the outer wall 208 may include protrusions, such as vanes or fins extending from the surfaces of the upper wall 204 and/or the outer wall 208 into the interior region 306. The vanes and/or fins may be configured to induce vortices or flow into the fluid when the separator 200 rotates.

The base of the outer wall 208 may include an interface structure 502 configured to interface with a complementary interface structure 602 of the base 210. For example, the interface structure 502 and the complementary interface structure 602 may be threaded interfaces formed with complementary threads, such that the base 210 may be secured to the outer wall 208 by the threaded interface formed from the interface structure 502 and the complementary interface structure 602. In other embodiments, the interface structure 502 and the complementary interface structure 602 may include interference structures, such as clips, protruding lips, etc., configured to secure the base 210 to the outer wall 208. The interface structure 502 and the complementary interface structure 602 are configured to position the base 210 relative to the separator 200, such that the axis 218 of the separator 200 is substantially aligned with the axis 218 of the base 210.

The central aperture 212 and the inward protrusion 302 may be formed as part of the base 210, such that when the base 210 is removed from the separator 200, the inward protrusion 302 and the central aperture 212 are removed with the base 210.

The separator 106, 200 according to embodiments of the disclosure may be used to remove impurities or desired materials from molten salt systems, such as in molten salt heat transfer and thermal storage media, molten salt fluid fueled reactors, molten salt batteries, or pyro/electrochemical processing of used nuclear fuels. By way of example only, the separator 106, 200 according to embodiments of the disclosure may be used to remove fission products that are formed in a molten salt pool, which increases the life of the molten salt pool. The separator 106, 200 may be disposed in the molten salt pool and used to separate and collect heavier impurities from the molten salt pool. However, the separator 106, 200 may also be used in other fluid systems to separate components based on differences in density or thermodynamic stability properties.

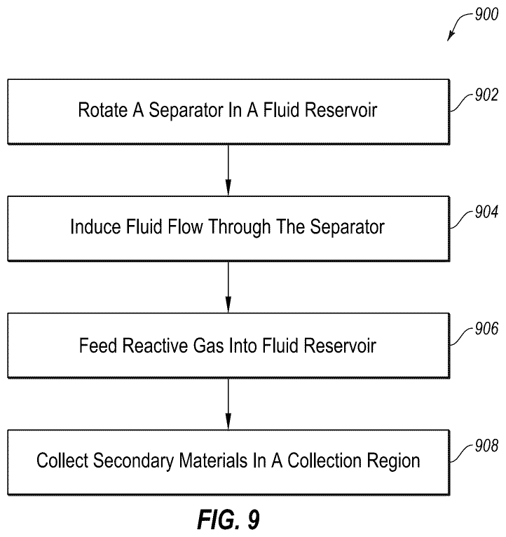

FIG. 7 illustrates a method 700 of removing secondary materials from a fluid reservoir. A separator, such as separator 106, 200 is disposed in the fluid reservoir containing a fluid. The separator is rotated in act 702 while disposed in the fluid, which includes materials of different densities or different molecular weights. The separator may be rotated at a speed greater than about 1,000 revolutions per minute (rpm), such as in a range from about 1,000 rpm to about 10,000 rpm, such as from about 1,200 rpm to about 5,000 rpm.

Rotating the separator in act 702 may induce a fluid flow through the separator in act 704. The fluid flow may enter the separator through a central aperture (e.g., central aperture 108, 212) in the base (e.g., base 110, 210) and exit the separator through apertures (e.g., aperture 118, 206) in the upper wall (e.g., upper wall 114, 204). The geometry of the interior region (e.g., interior region 130, 306) of the separator may cause vortices to form in the fluid flow through the interior region of the separator before the fluid flows out the apertures in the upper wall of the separator.

The vortices formed in the fluid flow through the interior region of the separator may cause secondary materials in the fluid that have a higher density than other materials of the fluid to concentrate within a collection region of the separator in act 706. In some embodiments, the secondary materials are solid or insoluble materials suspended in the fluid. In other embodiments, the secondary materials are fluid materials that have a higher molecular weight than the other materials of the fluid. The secondary materials may be removed and recovered from the fluid by removing the separator from the system and collecting the secondary materials collected in the collection region. The secondary materials may be removed as they are formed, enabling in situ removal of the secondary materials.

FIG. 8 illustrates a method 800 of removing secondary materials from a fluid reservoir. A separator, such as separator 106, 200 is disposed in the fluid reservoir. The separator is rotated in act 802 while disposed in the fluid. The separator may be rotated at a speed greater than about 1,000 revolutions per minute (rpm), such as in a range from about 1,000 rpm to about 10,000 rpm, such as from about 1,200 rpm to about 5,000 rpm.

Rotating the separator in act 802 may induce a fluid flow through the separator in act 804. The fluid flow may enter the separator through a central aperture (e.g., central aperture 108, 212) in the base (e.g., base 110, 210) and exit the separator through apertures (e.g., aperture 118, 206) in the upper wall (e.g., upper wall 114, 204). The geometry of the interior region (e.g., interior region 130, 306) of the separator may cause vortices to form in the fluid flow through the interior region of the separator before the fluid flows out the apertures in the upper wall of the separator.

A voltage may be applied through the fluid in act 806. The voltage may be applied between two electrodes (e.g., an anode and a cathode). One of the electrodes may be the separator. The voltage may cause secondary materials in the fluid to be attracted to the separator. The voltage applied between the electrodes may approach the decomposition potential of a secondary material that is less thermodynamically stable than the base liquid. For example, the voltage applied may be about 100 mV less than the decomposition potential of a secondary material that is less thermodynamically stable than the base liquid.

The vortices formed in the fluid flow through the interior region of the separator may cause secondary materials in the fluid that have a higher density than other materials of the fluid to concentrate within a collection region of the separator in act 808. Furthermore, the attraction between the separator and the less thermodynamically stable materials in the fluid may assist in causing the secondary materials to concentrate in the collection region of the separator in act 808. In some embodiments, the secondary materials are solid or insoluble materials suspended in the fluid. In other embodiments, the secondary materials are fluid materials that have a higher molecular weight and/or lower decomposition potential than the other materials of the fluid. The secondary materials may be removed and recovered from the fluid by removing the separator and collecting the secondary materials collected in the collection region.

FIG. 9 illustrates a method 900 of removing secondary materials from a fluid in a fluid reservoir. A separator, such as separator 106, 200 is disposed in the fluid reservoir. The separator is rotated in act 902 while disposed in the fluid. The separator may be rotated at a speed greater than about 1,000 revolutions per minute (rpm), such as in a range from about 1,000 rpm to about 10,000 rpm, such as from about 1,200 rpm to about 5,000 rpm.

Rotating the separator in act 902 may induce a fluid flow through the separator in act 904. The fluid flow may enter the separator through a central aperture (e.g., central aperture 108, 212) in the base (e.g., base 110, 210) and exit the separator through apertures (e.g., aperture 118, 206) in the upper wall (e.g., upper wall 114, 204). The geometry of the interior region (e.g., interior region 130, 306) of the separator may cause vortices to form in the fluid flow through the interior region of the separator before the fluid flows out the apertures in the upper wall of the separator.

A reactive gas may be fed into the fluid in the reservoir in act 906. The reactive gas may be fed in by a reactive gas sparge. The reactive gas may convert soluble species in the liquid to insoluble species. For example, soluble neodymium (III) chloride in a base fluid may react with an oxygen-bearing sparge gas to produce insoluble neodymium oxides and oxychlorides.

The vortices formed in the fluid flow through the interior region of the separator may cause secondary materials, which are formed into insoluble species in the fluid formed from the reactive gas to concentrate within a collection region of the separator in act 908.

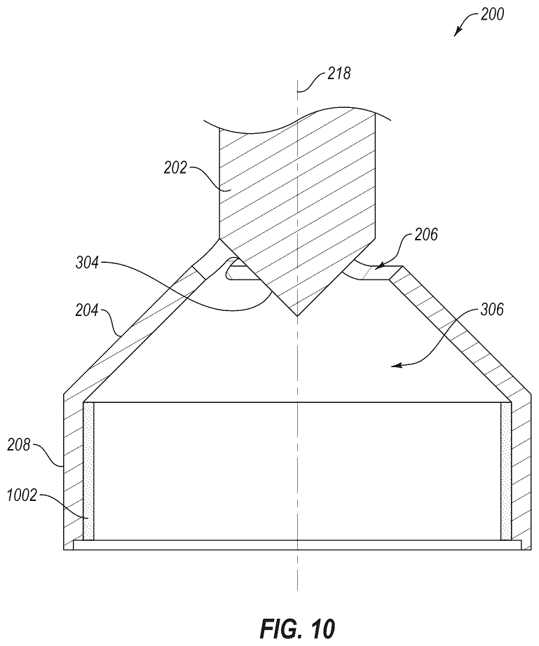

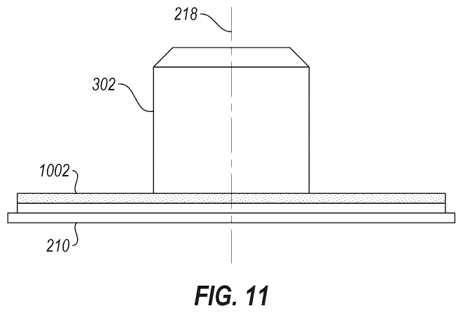

In FIGS. 10 and 11, another embodiment of the separator 200 with the removable base 210 is illustrated. FIG. 10 illustrates a cross-sectional view of the bottom portion of the separator 200 with the base 210 removed. FIG. 11 illustrates the removed base 210. The separator may be inserted or removed depending on demand for desirable particles to be recovered from a reactor.

In the embodiments illustrated in FIG. 10 and FIG. 11, the separator 200 includes a carrier metal 1002 disposed in the interior region 306. In the embodiment illustrated in FIG. 10, the carrier metal 1002 is disposed on the outer wall 208 on the side facing the interior region 306. In the embodiment illustrated in FIG. 11, the base 210 includes the carrier metal 1002 disposed over the base 210 around the inward protrusion 302. In some embodiments, the carrier metal 1002 is disposed both on the outer wall 208 and on the base 210. In other embodiments, the carrier metal 1002 may only be disposed on one of the outer wall 208 or the base 210.

The carrier metal 1002 may be a material that functions as a getter material for desirable insoluble particles. As used herein, a getter material is a material configured to capture desirable particles by combining with the desirable particles chemically or through absorption. Thus, when the desirable particles contact the getter material, the desirable particles are combined with the getter material either through chemical attraction or through absorption. The carrier metal 1002 may be used to minimize handling of a molten salt fuel containing the desirable insoluble particles.

The carrier metal 1002 may be configured to be a liquid at normal operating temperatures of the associated system. For example, the carrier metal 1002 may be configured to be a liquid at the normal operating temperatures of a molten salt nuclear reactor. A molten salt nuclear reactor may operate at temperatures in a range from about 400 °C to about 1,000 °C, such as from about 500 °C to about 900 °C. Therefore, the carrier metal 1002 may be configured to melt at temperatures at or below 400 °C.

When used with molten salt nuclear reactor systems, the carrier metal 1002 may also be a material that is inert to the molten salt fuel. The carrier metal 1002 may also have a greater density than the molten salt fuel, such that the carrier metal 1002 is not removed from the separator 200 by the induced vortices.

In some embodiments, the desirable particles are radioisotopes, such as one or more of molybdenum-99 (Mo-99), technetium-99m (Tc-99m), cobalt-60, iodine-131, iodine-123, thallium-201, chromium-51, carbon-11, gallium-67, etc. The carrier metal 1002 may be a material formulated to be a liquid at normal operating temperatures of an associated reactor and a getter for the associated radioisotopes. For example, the carrier metal 1002 may be one or more of zinc (Zn), bismuth (Bi), cadmium (Cd), gallium (Ga), indium (In), tin (Sn), lead (Pb), and alloys thereof.

In some embodiments, the carrier metal 1002 is disposed on the associated surfaces through a seeding process. In other embodiments, the carrier metal 1002 may be deposited over the associated surfaces through a deposition process, such as direct metal deposition, chemical vapor deposition, sputtering, etc. In other embodiments, the carrier metal 1002 may be placed in the interior volume of the separator 200 as a separate material in a solid or liquid form. For example, the carrier metal 1002 may be loaded into the interior volume of the separator 200 in a powder or particulate form through the apertures 206.

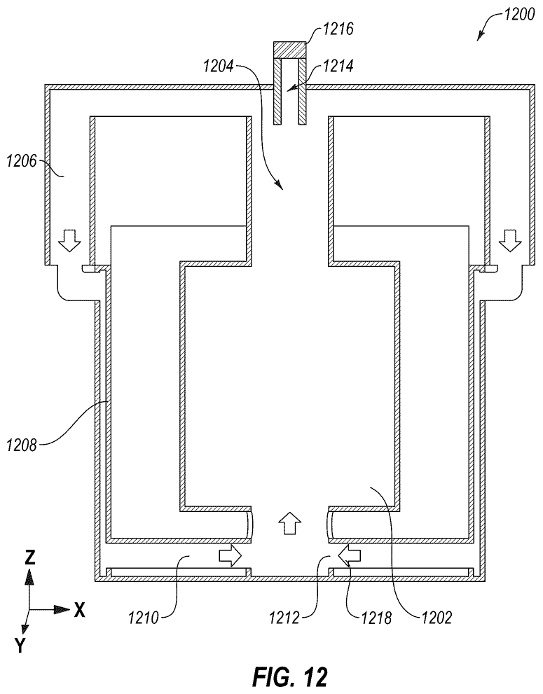

FIG. 12 illustrates a reactor 1200 configured to receive a separator, such as separator 106 or 200 (see FIGS. 1 and 2). The reactor 1200 includes a core 1202. In some embodiments, the nuclear fuel (not shown) is contained within the core 1202 and a cooling fluid (not shown) flows around the nuclear fuel transferring heat out of the core 1202. The path of the cooling fluid is shown by the arrows 1218 in FIG. 12. The cooling fluid may also carry particles through the reactor 1200, including impurities, insoluble particles, and radioisotopes. In some embodiments, the cooling fluid may include the fuel. For example, a molten salt nuclear fuel may flow through the reactor 1200 as a cooling fluid transferring heat generated by nuclear reactions in the molten salt nuclear fuel within the core 1202 to out of the core 1202.

The cooling fluid may flow out of the core 1202 into a riser 1204 above the core 1202 in the Z-direction. From the riser 1204, the cooling fluid may flow into one or more heat exchangers 1206. In some embodiments, the heat exchangers 1206 may be configured to transfer heat to another component (not shown), such as a power generator configured to convert the heat to electrical energy, such as through a steam generator, a sterling engine, etc. In other embodiments, the heat exchangers 1206 are configured to transfer heat to the surrounding environment to cool the cooling fluid. In the embodiment illustrated in FIG. 12, the fluid flows radially outward from the riser 1204 to the heat exchangers 1206, such that the heat exchangers 1206 are positioned radially outward from the core 1202 and the riser 1204. In other embodiments, the arrangement between the core 1202, the riser 1204, and the heat exchangers 1206 may be different. For example, the heat exchangers 1206 may be positioned vertically over the riser 1204 in a central position. In other embodiments, the heat exchangers 1206 may be separate from the reactor 1200 and connected through pipes or tubing.

After passing through the heat exchangers 1206, the cooling fluid returns to the core 1202, as indicated by the arrows 1218. In the embodiment illustrated in FIG. 12, the cooling fluid returns through one or more down tubes 1208, that are fluidically coupled to a return plenum 1210 coupled to a return manifold 1212. In some embodiments, the return plenum 1210 is formed from multiple tubes or pipes. In other embodiments, the return plenum 1210 is an open space configured to contain the cooling fluid around the return manifold 1212.

In some embodiments, the cooling fluid flows through the path discussed above through natural convection. For example, as the cooling fluid is heated in the core 1202, the cooling fluid rises through the core 1202 and the riser 1204 through natural convection. The cooler fluid in the return plenum 1210 may then rise into the core 1202, replacing the cooling fluid that rises out of the core 1202. Then, as the cooling fluid that rises out of the riser 1204 is cooled in the heat exchangers 1206, the cooling fluid flows downward through natural convection to replace the fluid in the return plenum 1210. In other embodiments, an additional pumping element may be configured to induce flow of the cooling fluid through the reactor 1200.

In some embodiments, the heat generated by the reactor 1200 is minimized. For example, in a reactor 1200 configured to produce radioisotopes, the main purpose of the reactor 1200 may be the production of the isotopes and the heat generated may be expelled as waste heat through the heat exchangers 1206. Therefore, the reactor 1200 may be configured to operate at lower temperatures or at a lower temperature differential across the core 1202 to reduce the waste heat generated. In this type of reactor 1200, the flow through the reactor 1200 may also be lower than a reactor 1200 used to generate power.

The reactor 1200 may include an access port 1214 configured to facilitate a separator (e.g., separator 106, 200) to be inserted into the flow path of the cooling fluid. In the embodiment illustrated in FIG. 12, the access port 1214 is positioned vertically above the riser 1204 and the core 1202. The access port 1214 includes a cap 1216. The cap 1216 may be a removable cap 1216. In some embodiments, the access port 1214 may include multiple closures, such as valves etc., configured to operate as a fluid lock, such that the cap 1216 may be removed during operation of the reactor 1200 without releasing the cooling fluid. When the cap 1216 is removed, the separator may be inserted into the access port 1214. The separator may include interfacing hardware configured to seal the access port 1214 when the separator is inserted through the access port 1214 to further prevent the cooling fluid from flowing out of the reactor 1200 through the access port 1214.

Once the separator is inserted through the access port 1214, the separator may be disposed within the cooling fluid in the riser 1204 and/or the core 1202. When the separator is disposed in the cooling fluid in the riser 1204 and/or the core 1202, the separator may be rotated inducing flow of the cooling fluid through the separator as discussed in detail above. The separator may then collect secondary materials, such as impurities, radioisotopes, insoluble particles, etc., suspended in the cooling fluid.

After the separator collects the secondary materials, the separator may be removed from the reactor 1200 through the access port 1214, and the cap 1216 may be replaced. The secondary materials collected in the separator may then be retrieved through other processes. For example, radioisotopes may be separated from a carrier metal (e.g., carrier metal 1002) and other insoluble particles and impurities may be cleaned out of the separator.

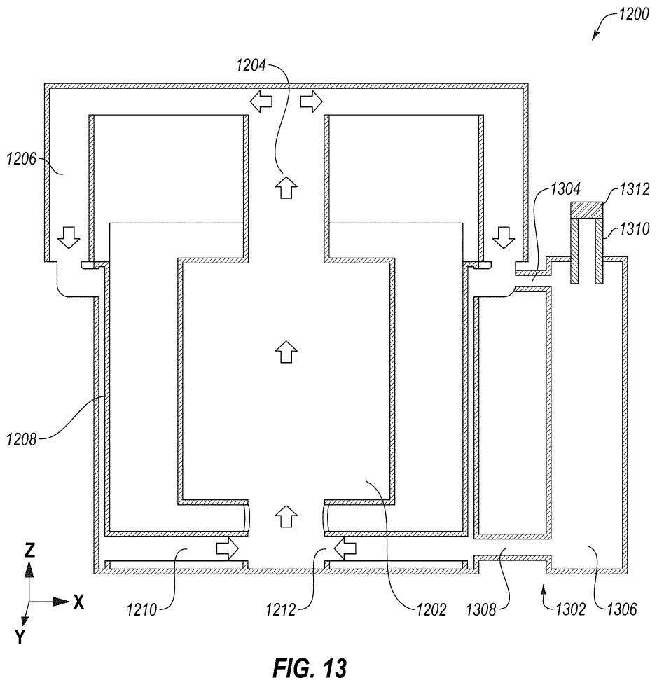

FIG. 13 illustrates another embodiment of the reactor 1200 configured to receive the separator (e.g., separator 106 or 200). As discussed above, the reactor 1200 includes a core 1202 where the nuclear reactions take place and a flow path for the cooling fluid that includes a riser 1204, one or more heat exchangers 1206, a down tube 1208, a return plenum 1210, and a return manifold 1212. As discussed above, the cooling fluid may be a separate fluid flowing around the nuclear fuel or the cooling fluid may be a fuel containing fluid, such as a molten salt.

In some embodiments, a bypass 1302 may be positioned between two portions of the flow path of the cooling fluid. In the embodiment illustrated in FIG. 13, the bypass 1302 is positioned between the heat exchangers 1206 and the return plenum 1210. In other embodiments, the bypass 1302 may be positioned between other components, such as between the riser 1204 and the heat exchangers 1206, between the down tube 1208 and the return plenum 1210, or between the heat exchangers 1206 and the down tube 1208.

The bypass 1302 may include a bypass line 1304 coupled to a reservoir 1306. The bypass line 1304 may include one or more valves, such that the cooling fluid selectively flows into the reservoir 1306 through the bypass line 1304. For example, when the valves are open, the cooling fluid may flow into the reservoir 1306 through the bypass line 1304. When the valves are closed the cooling fluid may flow through the flow path defined in the reactor 1200. The bypass 1302 may also include a return line 1308 coupling the reservoir 1306 to the reactor 1200 in a different position from the bypass line 1304.

In some embodiments, the bypass line 1304 and the return line 1308 are connected to the reactor 1200 in different regions. For example, the bypass line 1304 may be coupled to the reactor 1200 in the region associated with the heat exchangers 1206 and the return line 1308 may be coupled to the reactor 1200 in the region associated with the return plenum 1210 as illustrated in FIG. 13. In other embodiments, the bypass line 1304 and the return line 1308 may be adjacent to one another in a same region. For example, the bypass line 1304 and the return line 1308 may each be coupled to the down tube 1208 adjacent to one another.

The reservoir 1306 may include an access port 1310 configured to facilitate a separator (e.g., separator 106, 200) to be inserted into the reservoir 1306. The access port 1310 includes a cap 1312. The cap 1312 may be a removable cap 1312. In some embodiments, the access port 1310 may include multiple closures, such as valves etc., configured to operate as a fluid lock, such that the cap 1312 may be removed while the cooling fluid is flowing through the bypass 1302 without releasing the cooling fluid. When the cap 1312 is removed, the separator may be inserted into the access port 1310. The separator may include interfacing hardware configured to seal the access port 1310 when the separator is inserted through the access port 1310 to further prevent the cooling fluid from flowing out of the reservoir 1306 through the access port 1310. In some embodiments, the cooling fluid is flowing through the bypass 1302 when the cap 1312 is removed from the access port 1310 and the separator is inserted into the access port 1310. In other embodiments, the reservoir 1306 may be fluidically separated from the flow path through the reactor 1200, such as by closing valves in the bypass line 1304 and the return line 1308 before removing the cap 1312 from the access port 1310 and inserting the separator.

Once the separator is inserted through the access port 1310, the separator may be disposed within the cooling fluid in the reservoir 1306. When the separator is disposed in the cooling fluid in the reservoir 1306, the separator may be rotated, inducing flow of the cooling fluid through the separator as discussed in detail above. The separator may then collect secondary materials, such as impurities, radioisotopes, insoluble particles, etc., suspended in the cooling fluid.

After the separator collects the secondary materials, the separator may be removed from the reservoir 1306 through the access port 1310, and the cap 1312 may be replaced. The secondary materials collected in the separator may then be retrieved through other processes. For example, radioisotopes may be separated from a carrier metal (e.g., carrier metal 1002) and other insoluble particles and impurities may be cleaned out of the separator.

By separating and recovering the radioisotopes, the radioisotopes are prevented from accumulating in the reactor 1200. The recovered radioisotopes may be used as radiopharmaceuticals. For instance, Mo-99 may be recovered and used as a radiopharmaceutical. However, other desirable secondary materials may be recovered. The radioisotopes may exhibit a greater density than that of the molten salt, enabling the radioisotopes to be separated under centrifugal force.

Embodiments of the disclosure may facilitate separating secondary materials from fluid systems in situ, while the system is in operation. In many cases, secondary materials reduce efficiencies of the associated fluid systems, such as by creating flow restrictions or through parasitic reactions. In some systems, the secondary materials may be desirable materials formed through reactions in the fluid system. Collecting the secondary materials in situ may result in a more efficient system, which may reduce operating costs and increase production associated with the fluid system. The methods according to embodiments of the disclosure may be used to separate the secondary materials without shutting down the system. Therefore, the system may remain online while the secondary materials are being separated.

The embodiments of the disclosure described above and illustrated in the accompanying drawing figures do not limit the scope of the invention, since these embodiments are merely examples of embodiments of the invention, which is defined by the appended claims and their legal equivalents. Any equivalent embodiments are intended to be within the scope of this disclosure. Indeed, various modifications of the disclosure, in addition to those shown and described herein, such as alternative useful combinations of the elements described, may become apparent to those skilled in the art from the description. Such modifications and embodiments are also intended to fall within the scope of the appended claims and their legal equivalents.

What is claimed is:

1. A device for separating secondary materials from a base liquid, the device comprising:
a base including a central aperture defined by an inward protrusion;
a collection region defined over the base between the inward protrusion and an outer wall of the base;
a carrier metal disposed in the collection region, the carrier metal formulated to capture the secondary materials in the base liquid; and
an upper wall comprising one or more apertures defined through the upper wall, wherein the one or more apertures are positioned radially outward of the central aperture.

2. The device of claim 1, further comprising a central shaft axially aligned with the central aperture of the base.

3. The device of claim 2, wherein the central aperture has an outer radial dimension that is less than or equal to an outer dimension of the central shaft.

4. The device of claim 2, wherein the central shaft comprises an electrode.

5. The device of claim 1, wherein the carrier metal comprises one or more of zinc, bismuth, cadmium, gallium, indium, tin, lead, and alloys thereof.

6. The device of claim 1, wherein the carrier metal is formulated to be a getter material for the secondary material.

7. The device of claim 1, wherein at least one aperture of the one or more apertures defined through the upper wall comprises a constant width portion extending between two semicircular portions.

8. The device of claim 1, wherein the one or more apertures defined through the upper wall are evenly spaced.

9. A system comprising:
a first electrode disposed in a fluid reservoir configured to contain a fluid comprising a base fluid and secondary materials;
a second electrode disposed in the fluid reservoir, the second electrode configured to exhibit an opposite polar charge from the first electrode; and
a separator comprising:
a central shaft coupled to the second electrode;
a base including a central passage defined by an inward protrusion;
a collection region defined over the base between the inward protrusion and an outer wall; and an upper wall comprising one or more apertures defined through the upper wall, wherein the one or more apertures are positioned radially outward of the central passage.

10. The system of claim 9, wherein the central shaft is configured to rotate the separator.

11. The system of claim 9, wherein the central shaft is substantially axially aligned with the central passage.

12. The system of claim 9, wherein the collection region includes a carrier metal configured to capture the secondary materials.

13. The system of claim 12, wherein the carrier metal is a molten metal at an operating temperature of the system.

14. The system of claim 12, wherein the carrier metal is configured to be a getter material for the secondary materials.

15. The system of claim 9, further comprising a nuclear reactor comprising the fluid reservoir.

16. The system of claim 9, wherein the fluid reservoir comprises a port and the separator is removably disposed into the fluid reservoir through the port.

17. A method of separating secondary materials from a fluid, the method comprising:
rotating a separator in a fluid reservoir containing a fluid comprising a base fluid and a secondary material the separator comprising a central aperture extending through a base of the separator and one or more apertures in an upper wall of the separator;
inducing fluid flow through the separator from the central aperture to the one or more apertures in the upper wall of the separator; and
collecting the secondary materials in a collection region defined over the base of the separator between the central aperture and a radially outer wall of the separator.

18. The method of claim 17, further comprising applying a voltage between an electrode disposed in the fluid reservoir and the separator.

19. The method of claim 18, wherein applying the voltage between the electrode and the separator comprises applying the voltage between an anode and a cathode, wherein the separator comprises the cathode.

20. The method of claim 17, further comprising attracting the secondary materials to a carrier material disposed in the collection region.
